(19) United States
(12) Patent Application Publication
(10) Pub. No.: US 2025/0180356 A1
(43) Pub. Date: Jun. 5, 2025

(54) Advanced Pedestrian Navigation Based on Inertial Gait Analysis and GPS Data

(71) Applicant: Celloscope Ltd., Tel Aviv (IL)

(72) Inventors: Yuval MILO, Tel Aviv (IL); Yuval NAVEH, Haifa (IL)

(21) Appl. No.: 18/975,890

(22) Filed: Dec. 10, 2024

Related U.S. Application Data
(63) Continuation-in-part of application No. 18/939,288, filed on Nov. 6, 2024.
(60) Provisional application No. 63/612,587, filed on Dec. 20, 2023.
(60) Provisional application No. 63/557,740, filed on Feb. 26, 2024.
(60) Provisional application No. 63/557,747, filed on Feb. 26, 2024.
(60) Provisional application No. 63/557,753, filed on Feb. 26, 2024.
(60) Provisional application No. 63/557,757, filed on Feb. 26, 2024.
(60) Provisional application No. 63/557,762, filed on Feb. 26, 2024.
(60) Provisional application No. 63/596,479, filed on Nov. 6, 2023.

(51) Int. Cl. G01C 21/16; G01C 21/00; G01C 21/20; G01C 21/34; H04W 4/02; H04W 4/029

(52) U.S. Cl. CPC G01C 21/16; G01C 21/206; G01C 21/3423; G01C 21/383; H04W 4/027; H04W 4/029

(57) ABSTRACT

Method for processing users' cellphone data, the method comprising using a hardware processor for analyzing at least accelerometer (IMU) data provided by cellphones of at least a threshold number of users in a given location including recognizing at least one urban feature at said given location each time at least the threshold number of users, known to be present at the given location, exhibit a given motion pattern known by the processor to be characteristic of said urban feature; and/or generating a map including a stored representation of said at least one urban feature which is associated in memory with said given location at which the accelerometer data indicative of the urban feature was collected.

### FIELD OF THIS DISCLOSURE

The present invention relates generally to computerized analysis of motion, and more particularly to computerized analysis of human motion which receives sensor outputs borne by a human, typically in real time.

### CROSS-REFERENCE TO RELATED APPLICATIONS

The present application claims benefit of the following provisional applications, the entire contents of each of which being fully incorporated herein by reference: Application No. 63/612,587, filed Dec. 20, 2023; Application No. 63/557,740, filed Feb. 26, 2024; Application No. 63/557,747, filed Feb. 26, 2024; Application No. 63/557,753, filed Feb. 26, 2024; Application No. 63/557,757, filed Feb. 26, 2024, Application No. 63/557,762, filed Feb. 26, 2024; and Application 10 No. 63/596,479, filed Feb. 26, 2024. The present application is also a continuation-in-part of application Ser. No. 18/939,288, filed Nov. 6, 2024, the entire contents of which being hereby fully incorporated herein by reference.

### BACKGROUND FOR THIS DISCLOSURE

Dead reckoning typically approximates someone's current position based on her or his estimated movements from a previously known position. For example, given starting point coordinates, estimating heading (direction) then using velocity and time to estimate distance travelled between each change in direction, if any, enables computing the current position, e.g., by summing vectors of distance travelled between each change in direction.

Pedestrian dead reckoning (PDR) is a navigation method which estimates a person's position based on their last known location and their movement from that point, used, e.g., in environments where GPS signals are weak or unavailable, such as indoors, including urban canyons or campuses, and other urban areas where features are typically small relative to roads. This technique may rely on data from various sensors, such as:

Accelerometers: Measure acceleration to determine movement speed and direction.

Gyroscopes: Track orientation and turning movements.

Magnetometers: Help correct for changes in direction relative to magnetic north.

Conventional PDR integrates data from such sensors, yielding an estimate of a pedestrian's location which is accurate over short distances, whereas, regarding longer distances, errors can accumulate over time, e.g., due to sensor drift and changes in walking patterns.

US Patent Application #20240315601 assigned to Apple describes monitoring user health using gait analysis.

OneStep is an FDA-listed medical app, downloadable from GooglePlay, that uses smartphone motion sensors to provide immediate, clinically-validated feedback on gait inter alia.

The disclosures of all publications and patent documents mentioned above and elsewhere in the specification, and of the publications and patent documents cited therein directly or indirectly, are hereby incorporated herein by reference in their entirety. If the incorporated material is inconsistent with the express disclosure herein, the interpretation is that the express disclosure herein describes certain embodiments, whereas the incorporated material describes other embodiments. Definition/s within the incorporated material may be regarded as one possible definition for the term/s in question.

### SUMMARY OF CERTAIN EMBODIMENTS

According to one aspect of the presently disclosed subject matter there is provided a method for processing users' cellphone data, the method comprising:
a. using a hardware processor for analyzing at least accelerometer (imu) data provided by cellphones of at least a threshold number of users in a given location including recognizing at least one urban feature at the given location each time at least the threshold number of users, known to be present at the given location, exhibit a given motion pattern known by the processor to be characteristic of the urban feature; and/or
b. generating a map including a stored representation of the at least one urban feature which is associated in memory with the given location at which the accelerometer data indicative of the urban feature was collected.

In addition to the above features, the method according to this aspect of the presently disclosed subject matter can comprise one or more of features (i) to (vii) listed below, in any desired combination or permutation which is technically possible:
(i) deriving, from the map of the at least one urban structure at least one route for vehicles/pedestrians to follow including providing navigation instructions to users.
(ii) wherein the urban feature comprises a corridor and wherein the motion pattern known by the method to be characteristic of a corridor comprises a (typically) continuous sequence of strides over the trail without stops or interruptions.
(iii) wherein the urban feature comprises a hall and wherein the motion pattern known by the method to be characteristic of a hall comprises continuous sequences of strides crossing each other rather than overlapping.
(iv) wherein the urban feature comprises a doorway and wherein the motion pattern known by the method to be characteristic of a doorway comprises (above x % threshold) stops from among a set of users proceeding along the trail. There may not be 100% stops since the door may sometimes be open. (v) wherein the urban feature comprises a parking area and wherein the motion pattern known by the method to be characteristic of the parking area comprises more than N1 users in that area, transitioning from walking->sitting aka STOP class->driving and/or more than N2 users in that area, transitioning from driving->sitting aka STOP class->walking.
(vi) wherein the urban feature comprises a room, and wherein the motion pattern known by the method to be characteristic of a room comprises a pattern wherein all trails arriving at a certain location go through a doorway.
(vii) wherein the urban feature comprises a staircase, and wherein the motion pattern known by the method to be characteristic of the staircase comprises execution of stair-climbing activity, and wherein data from at least one user's mobile phone's accelerometer is used to classify the user's motion as either stair-climbing activity or as at least one activity other than stair-climbing.

According to an aspect of the presently disclosed subject matter there is provided an improved tracking system comprising a hardware processor configured for:
tracking at least one user by repeatedly computing at least one user's current location including estimating the user's movements from a previously known location of the user, thereby to generate a trail followed by the user; and
partitioning the trail into footsteps aka foot traces.

This aspect of the disclosed subject matter can comprise one or more of features (i) to (vii) listed above with respect to the method, mutatis mutandis, in any desired combination or permutation which is technically possible.

According to yet another aspect of the presently disclosed subject matter there is provided an improved tracking method comprising:
tracking at least one user by repeatedly computing at least one user's current location including estimating the user's movements from a previously known location of the user, thereby to generate a trail followed by the user; and
partitioning the trail into footsteps aka foot traces.

This aspect of the disclosed subject matter can comprise one or more of features (i) to (vii) listed above with respect to the method, mutatis mutandis, in any desired combination or permutation which is technically possible.

In addition to the above features, the method according to this aspect of the presently disclosed subject matter can comprise one or more of features (i) to (vii) listed below, in any desired combination or permutation which is technically possible:
(i) wherein the using and/or the generating is used for at least one of:
   a. Tracking pedestrian trail and estimating trail distance;
   b. Mapping rooms inside a building;
   c. Mapping spatial routes or walking routes for pedestrians and ranking their accessibility;
   d. Navigating inside a building or built-up area.
(ii)_wherein the partitioning comprises extraction of gait analysis from inertial data; and fusion of GPS data, when available, with IMU readings aka inertial measurements and/or gait analysis output e.g. stride length and/or the user's heading.
(iii) wherein a Kalman filter or derivation thereof is used for the fusion.
(iv) wherein the Kalman filter has at least one parameter whose value/s differ/s between motion interval types.
(v) wherein the motion interval types comprise at least one of:
   Device Transition—change of the position of the measurement device
   Shake—some unrecognized significant movement.
   Stops—the measurement device is stationary, possibly indicating that the subject is standing in place or that the measurement device is placed aside.
   Turns—the subject is turning or changing course (direction of movement) between adjacent strides significantly (e.g. more than 30 degrees)
   Strides
(vi) wherein the inertial data comprises typically continuous inertial data calibrated to the north and/or GPS locations over time.
(vii) wherein the tracking and/or the portioning is used for at least one of:
   a. Tracking pedestrian trail and estimating trail distance;
   b. Mapping rooms inside a building;
   c. Mapping spatial routes or walking routes for pedestrians and ranking their accessibility;
   d. Navigating inside a building or built-up area.

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented, as appropriate. Also provided, excluding signals, is a computer program comprising computer program code means for performing any of the methods shown and described herein when said program is run on at least one computer; and a computer program product, comprising a typically non-transitory computer-usable or -readable medium e.g. non-transitory computer-usable or -readable storage medium, typically tangible, having a computer readable program code embodied therein, said computer readable program code adapted to be executed to implement any or all of the methods shown and described herein. The operations in accordance with the teachings herein may be performed by at least one computer specially constructed for the desired purposes, or a general-purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display, e.g., on a computer screen or other computer output device, store, and accept information such as information used by or generated by any of the methods and apparatus shown and described herein; the above processor/s, display and input means including computer programs, in accordance with all or any subset of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as flash drives, optical disks, CDROMs, DVDs, BluRays, magnetic-optical discs or other discs; RAMs, ROMs, EPROMS, EEPROMs, magnetic or optical or other cards, for storing, and keyboard or mouse for accepting. Modules illustrated and described herein may include any one or combination or plurality of: a server, a data processor, a memory/computer storage, a communication interface (wireless (e.g., BLE) or wired (e.g., USB)), a computer program stored in memory/computer storage.

The term “process” as used above is intended to include any type of computation or manipulation or transformation of data represented as physical, e.g. electronic, phenomena which may occur or reside e.g. within registers and/or memories of at least one computer or processor. Use of nouns in singular form is not intended to be limiting; thus the term processor is intended to include a plurality of processing units which may be distributed or remote, the term server is intended to include plural typically interconnected modules running on plural respective servers, and so forth.

The above devices may communicate via any conventional wired or wireless digital communication means, e.g., via a wired or cellular telephone network, or a computer network such as the Internet.

The apparatus of the present invention may include, according to certain embodiments of the invention, machine-readable memory containing or otherwise storing, a program of instructions, which, when executed by the machine, implements all or any subset of the apparatus, methods, features, and functionalities of the invention shown and described herein. Alternatively, or in addition, the apparatus of the present invention may include, according to certain embodiments of the invention, a program as above which may be written in any conventional programming language, and optionally a machine for executing the program, such as but not limited to a general-purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless stated otherwise, terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining”, “providing”, “accessing”, “setting” or the like, refer to the action and/or processes of at least one computer/s or computing system/s, or processor/s or similar electronic computing device/s or circuitry, that manipulate and/or transform data which may be represented as physical, such as electronic, quantities, e.g., within the computing system's registers and/or memories, and/or may be provided on-the-fly, into other data which may be similarly represented as physical quantities within the computing system's memories, registers or other such information storage, transmission or display devices, or may be provided to external factors, e.g., via a suitable data network. The term “computer” should be broadly construed to cover any kind of electronic device with data processing capabilities, including, by way of non-limiting example, personal computers, servers, embedded cores, computing systems, communication devices, processors (e.g., digital signal processors (DSPs), microcontrollers, field programmable gate arrays (FPGAs), application specific integrated circuits (ASICs), etc.) and other electronic computing devices. Any reference to a computer, controller, or processor, is intended to include one or more hardware devices, e.g., chips, which may be co-located or remote from one another. Any controller or processor may, for example, comprise at least one CPU, DSP, FPGA, or ASIC, suitably configured in accordance with the logic and functionalities described herein.

Any feature or logic or functionality described herein may be implemented by processor/s or controller/s configured as per the described feature or logic or functionality, even if the processor/s or controller/s are not specifically illustrated for simplicity. The controller or processor may be implemented in hardware, e.g., using one or more Application-Specific Integrated Circuits (ASICs) or Field-Programmable Gate Arrays (FPGAs), or may comprise a microprocessor that runs suitable software, or a combination of hardware and software elements.

The present invention may be described, merely for clarity, in terms of terminology specific to, or references to, particular programming languages, operating systems, browsers, system versions, individual products, protocols, and the like. It will be appreciated that this terminology or such reference/s is intended to convey general principles of operation clearly and briefly, by way of example, and is not intended to limit the scope of the invention solely to a particular programming language, operating system, browser, system version, or individual product, or protocol. Nonetheless, the disclosure of the standard or other professional literature defining the programming language, operating system, browser, system version, or individual product or protocol in question, is incorporated by reference herein in its entirety.

Elements separately listed herein need not be distinct components, and alternatively may be the same structure. A statement that an element or feature may exist is intended to include (a) embodiments in which the element or feature exists; (b) embodiments in which the element or feature does not exist; and (c) embodiments in which the element or feature exist selectably, e.g., a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate or route, or otherwise manipulate or process information as described herein and/or to perform functionalities described herein and/or to implement any engine, interface, or other system illustrated or described herein. Any suitable computerized data storage, e.g., computer memory, may be used to store information received by or generated by the systems shown and described herein. Functionalities shown and described herein may be divided between a server computer and a plurality of client computers. These or any other computerized components shown and described herein may communicate between themselves via a suitable computer network.

The system shown and described herein may include user interface/s e.g. as described herein, which may, for example, include all or any subset of: an interactive voice response interface, automated response tool, speech-to-text transcription system, automated digital or electronic interface having interactive visual components, web portal, visual interface loaded as web page/s or screen/s from server/s via communication network/s to a web browser or other application downloaded onto a user's device, automated speech-to-text conversion tool, including a front-end interface portion thereof and back-end logic interacting therewith. Thus, the term user interface or “UI” as used herein includes also the underlying logic which controls the data presented to the user, e.g., by the system display, and receives and processes and/or provides to other modules herein, data entered by a user, e.g., using her or his workstation/device.

### BRIEF DESCRIPTION OF THE DRAWINGS

Certain embodiments of the present invention are illustrated in the following drawings; in the block diagrams, arrows between modules may be implemented as APIs, and any suitable technology may be used for interconnecting functional components or modules illustrated herein in a suitable sequence or order, e.g., via a suitable API/Interface. For example, state-of-the-art tools may be employed, such as but not limited to Apache Thrift and Avro which provide remote call support. Or, a standard communication protocol may be employed, such as but not limited to HTTP or MQTT, and may be combined with a standard data format, such as but not limited to JSON or XML. According to one embodiment, one of the modules may share a secure API with another module. Communication between modules may comply with any customized protocol or customized query language, or may comply with any conventional query language or protocol.

FIGS. 1-5 are simplified flowchart illustrations of methods (in which all or any subset of the operations may be performed) which are useful for performing embodiments of the present invention.

Methods and systems included in the scope of the present invention may include any subset or all of the functional blocks shown in the specifically illustrated implementations by way of example, in any suitable order, e.g., as shown. Flows may include all or any subset of the illustrated operations, suitably ordered, e.g., as shown. Tables herein may include all or any subset of the fields and/or records and/or cells and/or rows and/or columns described.

Computational, functional or logical components described and illustrated herein can be implemented in various forms, for example as hardware circuits, such as but not limited to custom VLSI circuits or gate arrays or programmable hardware devices such as but not limited to FPGAs, or as software program code stored on at least one tangible or intangible computer-readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences, such as but not limited to objects, procedures, functions, routines, and programs, and may originate from several computer files which typically operate synergistically.

Each functionality or method herein may be implemented in software (e.g. for execution on suitable processing hardware such as a microprocessor or digital signal processor), firmware, hardware (using any conventional hardware technology such as Integrated Circuit Technology) or any combination thereof.

Functionality or operations stipulated as being software-implemented may alternatively be wholly or fully implemented by an equivalent hardware or firmware module, and vice-versa. Firmware implementing functionality described herein, if provided, may be held in any suitable memory device, and a suitable processing unit (aka processor) may be configured for executing firmware code. Alternatively, certain embodiments described herein may be implemented partly or exclusively in hardware, in which case all or any subset of the variables, parameters, and computations described herein may be in hardware.

Any module or functionality described herein may comprise a suitably configured hardware component or circuitry. Alternatively or in addition, modules or functionality described herein may be performed by a general purpose computer, or more generally by a suitable microprocessor, configured in accordance with methods shown and described herein, or any suitable subset, in any suitable order, of the operations included in such methods, or in accordance with methods known in the art.

Any logical functionality described herein may be implemented as a real-time application, if, and as appropriate, and which may employ any suitable architectural option, such as but not limited to FPGA, ASIC, or DSP, or any suitable combination thereof.

Any hardware component mentioned herein may, in fact, include either one or more hardware devices, e.g., chips, which may be co-located or remote from one another.

Any method described herein is intended to include, within the scope of the embodiments of the present invention, also any software or computer program performing all or any subset of the method's operations, including a mobile application, platform or operating system, e.g., as stored in a medium, as well as combining the computer program with a hardware device to perform all or any subset of the operations of the method.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary, or off-line; which is of any type or level or amount or category of volatility, differentiation, mutability, accessibility, addressability, capacity, performance and energy use; and which is based on any suitable technologies such as semiconductor, magnetic, optical, paper, and others.

### DETAILED DESCRIPTION OF CERTAIN EMBODIMENTS

Certain embodiments seek to integrate PDR (or any other pedestrian navigation technology) with gait analysis and enable (inter alia) presentation of foot traces or individual strides over a trail.

PDR is a component that may be part of a larger pedestrian navigation system, helping improve position estimates when GPS or other signals are unreliable.

Pedestrian dead reckoning typically is augmented by at least one location from an external source e.g. at least one (typically time-stamped) GNSS e.g. GPS data point aka “EVENT”, or any other anchoring position or external location datum, is typically known, along any given trail or sequence of IMU/accelerometer measurements which is to be analyzed.

Certain embodiments seek to provide partitioning all or some or most of the time-line of an accelerometer output data stream, including classifying plural types of non-gait intervals, rather than selecting portions of the time-line which appear to be gait data, and discounting, ignoring, or discarding the rest of the time-line.

In this disclosure, any suitable number of readings may be generated by the accelerometer, e.g., the accelerometer sampling frequency may be 50-100 Hz (or more, or less).

Pedestrian Navigation typically refers to the process of computing the position of human subjects, e.g., while walking or running, which can be executed online or retroactively. Compared to satellite navigation using the Global Positioning System, Pedestrian Navigation, which is based on Gait Analysis using also inertial data, can be much more accurate and enable further applications.

Certain exemplary embodiments can provide an apparatus which may be wearable by a user. The apparatus may comprise all or any subset of an inertial measurement unit (IMU), compass, and Global Positioning System (GPS). The apparatus can comprise also additional sensors such as a barometer. The apparatus can comprise a processor (on-device or remote through Internet connection) constructed to perform (i) gait analysis based on the inertial data, e.g., from the IMU and/or (ii) data fusion to enhance the accuracy of location estimation by fusing data from all or any subset of the three sources of GPS locations, inertial measurement, and gait data. Gait data can include the direction of movement (yaw), stride segmentation, and length and inclination of each stride, or any subset.

Such a device may be configured to perform all or any subset of the following operations, in any suitable order, e.g., as follows:
1. Collection of (typically continuous AKA sequential, e.g., collect all readings generated by the accelerometer? inertial data typically calibrated to the north and GPS locations over time
and/or
2. Extraction of gait analysis typically from the inertial data using any known method e.g. as described in:
   a. US 2020/0289027 entitled “System, method and computer program product for assessment of a user's gait” (patents.google.com/patent/US20200289027A1/en?oq=naveh+US+2020% 2f0289027) and/or as described in
   b. United States of America published, co-owned US 2022/0111257 entitled “System, Method and Computer Program Product Configured for Sensor-Based Enhancement of Physical Rehabilitation” patents.google.com/patent/US20220111257A1/en?oq=NAVEH+US+2022% 2f0111257 and/or as described in
   c. US 2023/0137198 entitled “Approximating Motion Capture of Plural Body Portions Using a Single IMU Device” patents.google.com/patent/US20230137198A1/en?oq=NAVEH+2023% 2f0137198++++++
   and/or
3. Data fusion (typically including Fusion of GPS data with inertial measurement and gait analysis) typically using Kalman filter, e.g. as follows:

Any suitable technology may be employed to yield inertial data calibrated to (say) north. IMUs typically use a magnetometer to find magnetic north and can adjust for true north with magnetic declination. The gyroscope typically facilitates tracking of orientation changes and typically provides stability. References in this disclosure to orientation may be interchanged with references to attitude. Typically, the accelerometer corrects for tilt, ensuring that the heading stays accurate. Through sensor fusion, the IMU typically integrates these sensor inputs to deliver precise orientation relative to north. To provide a stable and accurate orientation relative to north, IMUs may use sensor fusion algorithms (like Kalman filters and/or complementary filters) that combine data from the magnetometer, gyroscope, and accelerometer.
Inertial Measurement Units (IMUs) may provide orientation related to the north using a combination of sensors that measure various aspects of movement and orientation e.g. all or any subset of accelerometers, gyroscopes, and magnetometers. Primary Role: The magnetometer in an IMU measures the Earth's magnetic field to determine orientation relative to magnetic north.
The IMU can adjust the magnetic north reading to true north (geographic north) if it has information on the local magnetic declination (the angle difference between true north and magnetic north), which varies by location.
The gyroscope measures angular velocity, which helps track rotational movement.
Typically, the gyroscope, rather than supplying, alone, the direction relative to north, facilitates maintaining typically continuous orientation tracking and smoothing out magnetometer data, which can be noisy.

The accelerometer measures linear acceleration, which typically can be used to determine the direction of gravity by identifying the pitch and roll of the device (tilt angles) for correcting the magnetometer readings, because a magnetometer's accuracy is affected by the tilt of the device and for aligning the device's axis with the Earth's gravity, allowing the magnetometer and gyroscope data to be more accurately processed.
Typically, IMUs use “sensor fusion” algorithms (e.g. Kalman filters or complementary filters) to combine data from a magnetometer and/or gyroscope, and/or accelerometer. Thus, for example:
   The magnetometer typically provides the heading relative to magnetic north.
   The gyroscope typically tracks changes in orientation and helps provide smooth transitions by filling in gaps when the magnetometer reading is less reliable.
   The accelerometer typically ensures that pitch and roll are accounted for, allowing the device to correct any tilt and maintain an accurate north reading.
Thus, typically, the gyroscope helps maintain stable orientation over time, the accelerometer corrects for tilt, and the magnetometer corrects for drift in the gyroscope; sensor fusion combines all these, and yields long-term accuracy.

Any suitable sensor fusion may be used to calibrate the IMU orientation reading to the north, e.g. as provided in common IMU data APIs (such as those used in mobile apps in the Android OS and iOS).

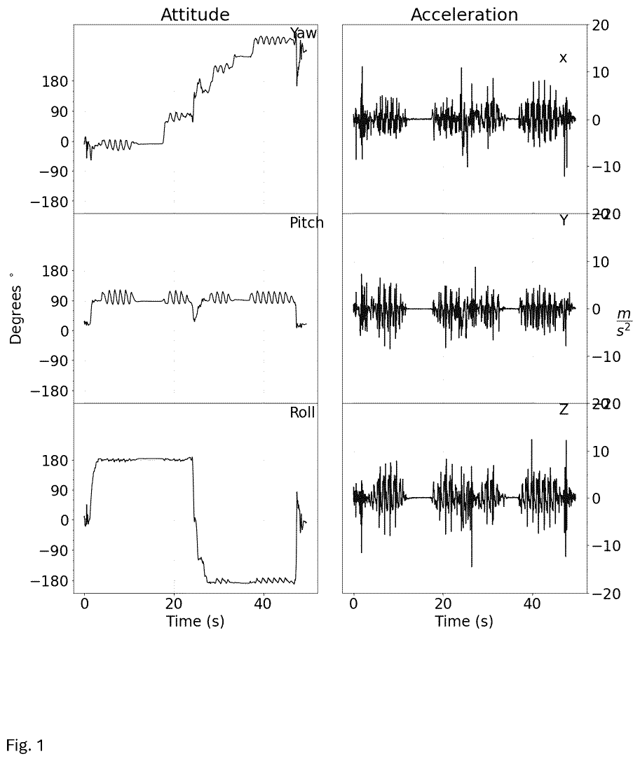

An example of calibrated typically continuous inertial measurement is presented in FIG. 1. Attitude values typically comprise Orientation (e.g. in Euler angles, yaw, pitch roll).

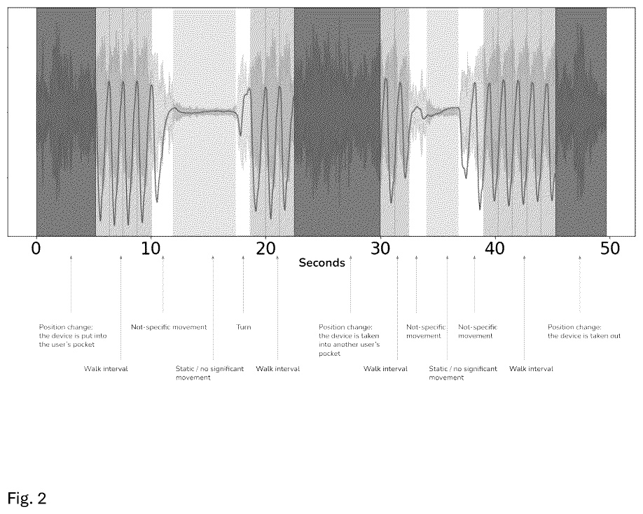

FIG. 2 pertains to description of analyzed motion including analysis of what the device is undergoing, both when gait (strides) is/are occurring, and when no gait is occurring. Typically, the method is configured for partitioning the entire time-line of the accelerometer output data stream, including classifying plural types of non-gait intervals, rather than selecting portions of the time-line which appear to be gait data, and discounting, ignoring, or discarding the rest of the time-line.

As part of the motion analysis, the method may get and/or receive and/or generate a segmentation of the signal into intervals of different categories of recognized activity e.g. as shown in FIG. 2. The different categories may include all or any subset of the following:
Transition—change of the position of the measurement device
Shake—some unrecognized significant movement
Stops—the subject is standing in place.
Turns—the subject is turning and changing his course (direction of movement) within a single stride significantly (more than 30 degrees)
Strides—detection of gait activity

In addition to the motion segmentation, analysis may produce the course or heading referred (or referenced) to, say, the north e.g. as described in co-owned published, co-owned US 2022/0111257, and/or to, say, altitude above sea level over time. It is appreciated that altitude data is typically available from the mobile phone's altimeter sensor.

Stage b—Determination of the Course of Movement

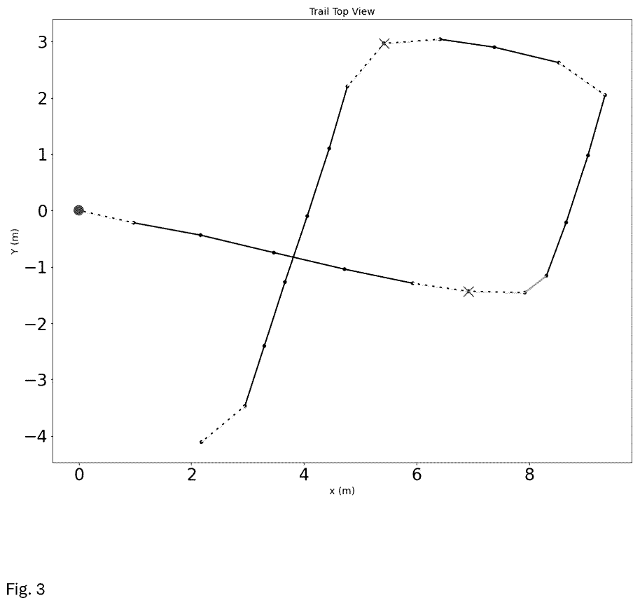

Integration of the course of movement with information from the analyzed motion yields an inertial trail as presented in FIG. 3. Such a trail can be optimized with the GPS data using any suitable method e.g. using the following data fusion method which assumes, say, typically continuous inertial measurement over time, GPS locations at a rate of x (e.g. 5 per minute), and motion and gait analysis. Data fusion may be processed as follows:

Typically, accelerometer output data is divided or portioned into typically continuous segments which may be classified as being of various types based on the type of activity detected by a motion gait analysis pipeline, e.g., as described herein. For each such typically continuous segment with a distinct type, data fusion may be applied (to get the state of the user, e.g., her or his location and/or velocity and/or heading) using the following algorithms:
a. Whenever the gait analysis pipeline detects a stop (which is one of the types of accelerometer output stream intervals), the method may assume the location is stationary and that the velocity is zero (this reduces the error caused by the inaccuracies of the GPS and the drift caused by the IMU).
b. Whenever a walking segment or interval that is not a turn is detected, the following data fusion algorithm is used (aspecific implementation of the non-linear Kalman Filter) to fuse GPS (when available) and/or the IMU, and/or the stride length.

Given the “real” state at time t, xₜ (that denotes the user's location at time t) and a control vector uₜ that denotes the stride length and heading at time t (that was computed by the gate analysis pipeline) the motion equation is xₜ₊₁=f(xₜ,uₜ)+vₜ. The equation that updates the user's location based on its location some time ago, the speed in the control vector, and the noise of the process vₜ. Using this motion model, and given the previous estimate of the user's location zₜ at time t, an estimate of the user's location at time can be created, t+1, based solely on the estimate at time t by evaluating eₜ₊₁=f(zₜ,uₜ). Then, given a new measurement yₜ₊₁ of the IMU and GPS (or just the IMU during GPS outages) that can be written as yₜ₊₁=h(xₜ)+wₜ (a noisy measurement of the state) where wₜ is the noise of the measurement at time t, the new measurement may be combined with the new estimate, creating a better estimate, using the following operations b-I, b-ii:
b-i. Start with predicting the state at time t+1 based on the previous estimate, computing eₜ₊₁=f(zₜ,uₜ) and Pₜ₊₁=FₜPₜFₜ^{T}+Qₜ, where eₜ₊₁ is the new estimate, Qₜ is the covariance of the process noise (vₜ) at time t, Fₜ is the Jacobian of f computed at zₜ, uₜ, and Pₜ is the covariance of the estimation process (used to update our estimate later) at time t.
b-ii. Continue by updating the estimate with the new measurements by computing Gₜ₊₁=Pₜ₊₁Hₜ₊₁^{T}(Hₜ₊₁Pₜ₊₁Hₜ₊₁−R)⁻¹ and zₜ₊₁=zₜ+Gₜ₊₁(yₜ₊₁−h(eₜ₊₁)).
where Pₜ is the covariance of the estimation process, Hₜ is the Jacobian of h computed at zₜ,uₜ and R is the covariance matrix of the noise between sensors.

Operations b-I, b-ii yield a stream of estimates zₜ of the state at time t. Whenever the method detects a walking segment that is not a stop, and not a stride, the classical Kalman filter (e.g. as described above) may be used to fuse the GPS data (when available) and the IMU to get the state development dynamic over time. In such a case the control vector uₜ will be removed from the dynamic and the speed of movement to the state zₜ will be added, encompassing the state update based on speed into the function f. The starting state may be obtained from previous segments, and therefore a better approximation of the heading and velocity of the user should be provided, than by a Kalman filter without the gait analysis, resulting in lower variance of the posterior distribution over the states.

Given a measurement model dependent upon e.g. the GPS, the IMU, and the different gait analysis parameters, and given a motion process dependent upon, e.g., the location, the altitude, the orientation, and their corresponsive first and second derivatives, one could use Bayes theorem and marginalization to estimate a posterior distribution over the states at different times, based on past measurements. Such algorithms are usually referred to as sensor fusions. Some variant of sensor fusion may be used (the specific variant could be some variant of Kalman filter over the data, or a Kalman filter over the error caused by the accuracy of the sensors) to get better estimation than only from raw GPS and IMU fusion.

Applications of the above include, but are not limited to the following:
a. Tracking pedestrian trail and estimating trail distance accurately
b. Mapping rooms inside a building
c. Mapping spatial roots for pedestrians and ranking their accessibility
d. Navigating a courier directly to the customer's desk (navigation inside a building).

All or any subset of the following five classes or categories may be used to classify a sequence of imu data, e.g. as described herein and/or in published, co-owned US 2022/0111257 patents.google.com/patent/US20220111257A1/en?oq=US+2022% 2f0111257.
Device Transition—change of the position of the measurement device e.g. phone with accelerometer
Shake—significant movement which is unrecognized (e.g. not falling into any other class).
Stops—the measurement device is stationary,—possibly indicating that the subject is standing in place, or that the measurement device has been set aside and is not presently on the user's body.Turns—the subject is turning or changing course, or changing heading, or changing direction of movement. Typically, gyro readings may be used to yield a relative change in heading from one stride to another; a heading change between adjacent strides may be regarded as significant if over threshold (e.g. more than 30 degrees).Strides-detection of linear gait activity. Any repetitive mobility activity is considered as gait, such as walking, running, climbing stairs, going up/downhill, cycling (as described in Ser. No. 16/659,832 inter alia). Each stride (or cycle) is typically attached to or associated in memory with its estimated traveled distance (or stride length) and/or other gait measures corresponding to each stride, such as but not limited to all or any subset of the following: cadence, cadence variability, double support and single support of either leg, stride length asymmetry, and stride width.

Certain embodiments seek to identify at least one building feature, whether structural and/or functional, by identifying motion patterns characteristic to said functionality in accelerometer data provided by cellphones of at least a threshold number of users present in said area.

Certain embodiments seek to provide a processor configured for partitioning of an entire time-line of accelerometer data, including classifying plural types of non-gait intervals, rather than selecting portions of the time-line which appear to be gait data, and discounting, ignoring, or discarding the rest of the time-line, e.g., as described below with reference to FIG. 2.

### DETAILED DESCRIPTION OF THE INVENTION

An example Motion Semantic Segmentation method is now described in detail:

Partition motion, measured using an IMU, into intervals; the intervals may be characterized or classified as one of plural interval types or classes, the interval types typically including all or any subset of the following:
Device Transition aka position change-change of the position of the measurement device
Shake aka non-specific movement—some unrecognized significant movement.
Stops aka static—the measurement device is stationary, possibly indicating that the subject is standing in place, or that the measurement device is placed aside.
Turns—the subject is turning or changing course (direction of movement) between adjacent strides significantly (e.g. more than 30 degrees)
Strides aka walk interval
   To do this, all or any subset of the following operations may be employed:
   1300. Input inertial data from the apparatus, including accelerations in x, y, z (of the sensor reference frame), angular velocity, and orientation in the global reference frame (e.g., in yaw, pitch, roll).
   1310. Detection and segmentation of a repetitive pattern, e.g., as described in published, co-owned US 2022/0111257.
   1320. The segmentation of the repetitive patterns from 1310 defines the two classes of stride and turn intervals: repetitive intervals in which the yaw signal does not change by more than a threshold (say 30 degrees) are considered strides, and the rest of the repetitions are considered turns (since they occur during a significant change of heading as the change in yaw implies).
   1330. Now, all time intervals determined in operation 1320 are excluded for the rest of the process to identify other interval classes.
   1340. Stops—to identify intervals of this class, it is possible to use a sliding window over the remaining data from 1330. When the average acceleration magnitude is lower than 0.05 m/sec**2, the whole window at that position is considered static. Then, adjacent static intervals are merged, and their boundaries are modified to be the first interval's starting point and the last interval's ending point. Stop intervals are now also omitted for the rest of the interval identification flow.
   1350. The rest of the data is now divided into intervals that can be either device transition aka position change, or shakes, which are a class of all other unrecognized movements. Transitions are determined if the mean orientation significantly changes between the regions before and after the interval, where yaw can be ignored (since heading change may be considered turning rather than a change in the device's position or placement). So if the mean pitch changes by more than a threshold (say 20 degrees) or the mean roll changes by more than a threshold (say 20 degrees), then the interval is considered a device transition. And/or, if the intervals are at the beginning or at the end of the measured signal, they are considered device transitions by definition.
   1360. The rest of the intervals are shakes.

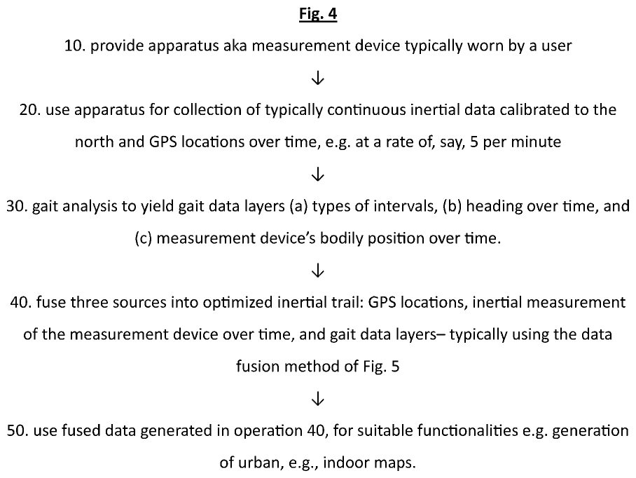

FIG. 4 is now described:
10. provide apparatus aka measurement device e.g. cellphone with built-in IMU including accelerometer, gyroscope, magnetometer, altimeter, and/or barometer, which is typically worn by a user
20. use apparatus for collection of typically time-stamped, typically continuous inertial data (typically calibrated to the north) and typically time-stamped, typically continuous GPS locations. The term “OVER TIME” herein typically refers to time-stamped data points
30. gait analysis-use a processor (on-device or remote through Internet connection) to extract gait analysis from the inertial data as described in U.S. patent application Ser. Nos. 16/659,832, 17/500,744, 63/272,839.
This motion analysis aka gait analysis yields (inter alia) all or any subset of the following data layers:
Data layer aka 30a. “motion semantic segmentation” over time including partitioning motion into intervals which each belong to one of plural categories of recognized activity, e.g., all or any subset of the following five categories:
a. Device Transition-change of the position of the measurement device e.g. phone with accelerometer
b. Shake—significant movement which is unrecognized (e.g. not falling into any other class); this is characteristic e.g. of a cellphone deployed in a moving vehicle. Typically, if a user moves his phone while he is turning, the class is SHAKE rather than TURN, because the net motion is not that of a turn, and if a user moves her phone while she is standing in place, the class is not STOP but SHAKE, because the net motion is not that of a stop.
c. Stops—the measurement device is stationary, possibly indicating that the subject is standing in place or that the measurement device has been set aside and is not presently on the user's body.

This may be identified as velocity zero, however it may be difficult to estimate velocity accurately, directly from IMUs. Alternatively or in addition, if for a period of time accelerations are static or very low e.g. less than 0.05 m/sec**2, this may be used to indicate that the sensor is static, or does not accelerate.
d. Turns—the subject is turning, or changing course, or changing heading, or changing direction of movement. Typically, gyro readings may be used to yield a relative change in heading from one stride to another; a heading change between adjacent strides may be regarded as significant if it is over a threshold (e.g. more than 30 degrees).
e. Strides—detection of linear gait activity. Any repetitive mobility activity is considered as gait, such as walking, running, climbing stairs, going up/downhill, cycling (as described in Ser. No. 16/659,832 inter alia). Each stride (or cycle) is typically attached to or associated in memory with its estimated traveled distance (or stride length) and/or other gait measures corresponding to each stride, such as but not limited to all or any subset of the following: cadence, cadence variability, double support and single support of either leg, stride length asymmetry, and stride width;
Data layer b aka 30b. subject's heading over time, in a plane e.g. relative to the north and/or altitude relative, say, to sea level (typically available from the user's devices' magnetometer and altimeter respectively); and
Data layer c aka 30c. measurement device's bodily position or placement over time. Any suitable method may be employed to identify bodily position (e.g. right hip pocket, left hand) in which the phone is located e.g. using the 2-way activity/bodily position classifier described in co-owned US20200289027A1). If the classifer outputs a bodily position, the system may then assume the user's device's position remains unchanged until a “device transition” interval is (next) detected. The classifier may then be reactivated each time a “device transition” interval is detected.

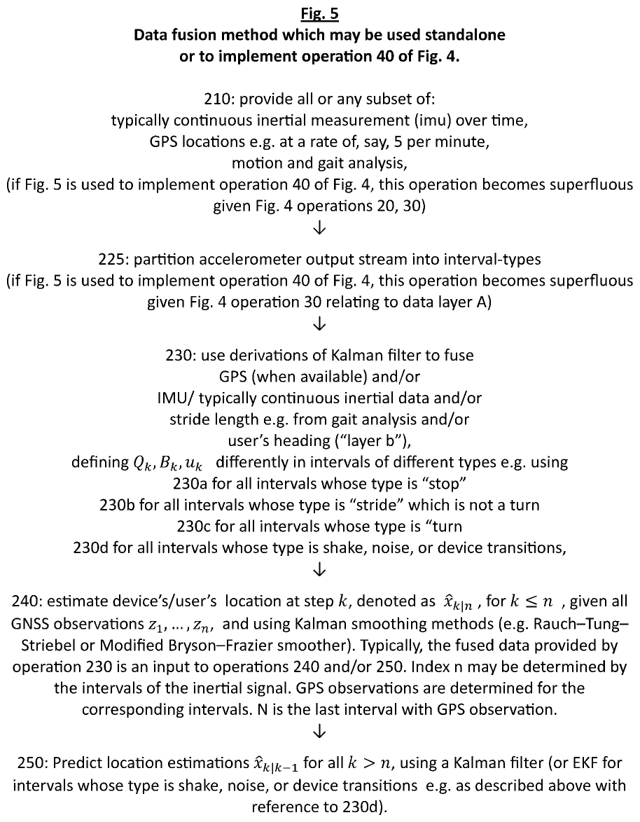

The system is typically configured to classify all data into five classes, and any data that is in “stride”, is again classified into activities, e.g., all or in a subset of the following activities which are all typically repetitive (walking, ascending, or climbing up stairs, descending or climbing down stairs, running, jumping, squatting, skipping, hopping, cycling). It is appreciated that being stationary, e.g., repeatedly doing nothing, either can or cannot be considered an activity.
40. generating an optimized inertial trail by fusion (using any suitable data fusion method e.g. the data fusion method of FIG. 5) of all or any subset of the following three sources:
Source 40i. GPS locations of the measurement device over time,
Source 40ii inertial measurement of the measurement device over time, and
Source 40iii. Gait data over time (including all or any subset of layers a, b, and c)
50. provide output from operation 40 to all or any subset of the following functionalities:
a. Tracking pedestrian trail and estimating trail distance accurately. This may utilize the direct or raw output of operation 40. Using Layer A over the trail allows the presentation of different gait and mobility activities along the user's way, such as where the user walks and climbs stairs, at which speed the user moves, and the approximate locations of each stride.
b. Mapping rooms inside a building for indoor-navigational purposes and/or the interior structure and the intended uses of the building and the rooms inside may be of interest, yet may be unknown. Many trails produced by flow 10-40 may be generated and stored (e.g., cloud storage or other data storage) for further offline analysis which may occur once enough trails have been collected (^{˜}10 per 100 square ft. per floor). For example, the universe being mapped may be partitioned into squares 100 ft long, or each time information collected from a user re a certain location suggests that this location has, say, a certain intended use, then the method searches memory to determine whether data collected re this location from nine other users who previously were present at this location also suggested that this location has this intended use; if so, then the intended use suggested by the accelerometer data of all ten users is assigned to this location.
Staircases and/or corridors and/or halls and/or doorway and/or rooms can, for example, be recognized as follows:
Staircase—Using layer A, the system may recognize the user's activity as stair climbing. Alternatively or in addition, Layer B provides the user's heading, which implies the staircase structure: one-way (e.g. all stairs lie along a single inclined plane), two-way (back and forth e.g. stairs lying along a first inclined plane, followed by a landing, followed by additional stairs lying along a second inclined plane) or n-way (e.g. staircase wending its way up an n/2-story building including a two-way staircase between each two adjacent floors), spiral, or any other structure. Layer A also provides the number of stairs (since most people will climb one stair at a time, such that, on average, the number of strides taken by a user climbing a flight of stairs, equals the number of stairs in the flight of stairs. It is appreciated that identifying how many stairs may be useful e.g., for mapping, e.g., to help understand elevation/height changes e.g. to establish transitions between floors.

Typically, the number of strides taken by the user climbing the flight of stairs is derived by segmenting motion data (e.g. raw data from the user's phone's accelerometer) and/or an entire timeline into strides e.g. as described in co-owned US20200289027A1, the disclosure of which is hereby incorporated herein by reference, then counting the number of strides which result from the segmentation.

It is appreciated that the system may distinguish between south vs west from the heading channel, and/or the system may distinguish between up/down by the type of activity, because climbing up or going down are different activities.

It is appreciated that according to certain embodiments, “staircase ascent” starts when strides stop being in a horizontal “z=0” direction and start being in upward direction; and
“staircase ascent” ends when strides stop being in the upward direction and revert again to the horizontal “z=o” direction;
“staircase descent” starts when strides stop being in a horizontal “z=o” direction and start being in a downward direction; and
“staircase descent” ends when strides stop being in the downward direction and revert again to the horizontal “z=o” direction.

Any suitable heuristics may be employed to derive a number of stairs from a number of strides. For example, on stairs, but not on escalators, there is typically a one-to-one correspondence between the number of stairs and the number of strides.

Detection and segmentation of a repetitive pattern in published, co-owned US 2022/0111257.

If the number of strides is known, then the number of stairs is known. Ascending or descending can be recognized by the activity recognition (these are two different gait activities), or by using the altimeter/barometers.

It is appreciated that data indicating whether an end-user is going up stairs or down enables floors of a building to be recognized and differentiated between. This is helpful, because aggregating trajectories or trials from different measurements e.g. from different devices, typically needs to occur, if and only if those trajectories are all on the same floor, i.e. if Joe is found to be engaged in ascent e.g. climbing up stairs, then any features which precede this stair-climbing activity of Joe's may be assigned to a system map of floor n, whereas any features occurring after this stair-climbing activity of Joe's may be assigned to a system map of floor n+1. Similarly, if Joe is found to be engaged in descent e.g. going down stairs, then any features which precede this stair-climbing activity of Joe's may be assigned to a system map of floor n, whereas any features occurring after this stair-climbing activity of Joe's may be assigned to a system map of floor n−1.

Any suitable method may be employed to determine which floor is the ground floor, e.g., is at the same level as the terrain outside the building. For example, the lowest floor found using the above technique based on identifying trajectories before and after stair-climbing, may be identified as the “ground floor”. Alternatively, or in addition, a user device's altimeters may be used to estimate floor level (although there may be situations where this estimation is off by +− a floor). Alternatively, or in addition, a parking area may be identified e.g. as described herein, and any floor on that level, may be deemed the building's “parking level”. Alternatively, or in addition, a ground floor which, e.g., when mapping, may be useful to identify, may be discerned by tracking an entrance to the building.

Segmentation may involve all or any subset of the following operations, suitably ordered, e.g., as follows:
Operation b1: Online data streaming: receive from a magneto-inertial sensor raw acceleration and/or rotation (angle) for all or any subset of three spatial channels aka yaw, pitch, and roll.
Operation b2: standardize the raw data received in operation b1 over all supported devices, to achieve continuity of measurements.
Operation b3: further standardize the data generated in operation b2, to achieve consistency of intervals between measurements over all supported devices.
Operation c: A time-window of, say, the last few seconds of data from operation (b) is analyzed in an attempt to discern a repetitive pattern, aka “motion pattern”.
Operation d: If a repetitive pattern is found in (c), then data from (b) is segmented according to the pattern. Otherwise, the flow typically ends here.

Typically, each segment represents a single cycle or a single stride, thus segmentation may produce objects (motion cycles/strides) for determination of a number of strides, e.g., number of stairs in a staircase.

Corridors can be identified as a (typically) continuous sequence of strides over the trail without stops or interruptions. A few repetitions (e.g. 2-3 or 10 or 50 or more) of the same overlapping corridor trail (e.g. plural users detected to be striding along the same trail without stops or interruptions) are sufficient to conclude that this trail portion is a corridor. Overlapping may be defined as able to be enveloped in a rectangle with, say, a width of 3 ft and a length of >10 ft.

Halls (used herein to include a transition area between rooms or corridors which is wider than a corridor) can be identified as an area that envelops different (typically) continuous sequences of strides crossing each other, rather than overlapping.

Doorways aka doorways can be identified as a position on the trail where there are (above x % threshold) stops from among a set of users proceeding along the trail. There may not be 100% stops since the doorway may sometimes be open. It is appreciated that stops aka v=0 may be derived by gait analysis by identifying intervals with almost static accelerations e.g. as described elsewhere herein.

It is appreciated that having knowledge of stride length and heading may be useful, e.g., in deriving a trail, and a trail may be useful to generate mapping, e.g., as described herein.

It is appreciated that alternatively or in addition, a user's cellphone's accelerometer can yield velocity information, even in the absence of a GPS. This velocity information could be used to identify stops, interruptions, etc. by identifying zero-velocity points in time, and building features may then be identified accordingly, e.g., people all seem to stop (v=0) at point P, so point P must be a doorway. However, using accelerometers to assess speed is not always accurate due to drifting; thus, identification of building features by gait analysis as described herein can resolve inaccuracies in building feature identification based on accelerometer-provided velocity and/or can be a more accurate alternative to building feature identification based on accelerometer-provided velocity.

### Room Identification:

If all trails arriving at a certain location go through a doorway, the system may conclude that this location is inside a room. Two locations connected by a trail, without a doorway or a corridor, may be considered in the same room.

Walls, rooms, spaces, and building layout typically envelop trails.

Given a population of users in motion, a suitable process for deciding which rooms exist, and where the walls are, may include all or any subset of the following operations, suitably ordered e.g. as follows:
a. find doorways and corridors;
b. for each user passing through a known doorway d, list all locations along the user's trail that the user visited after passing through doorway d, and stop listing when the user reaches a known doorway or corridor;
c. locations which are listed for 30 or more users, are deemed to be inside a room accessible via doorway d.

According to certain embodiments, the system may first identify all possible doorways and corridors, and, only then, may identify rooms.

It is appreciated that areas which are mapped, using data from users' devices collected at time t1 are preferably re-mapped, using data from users' devices collected at time t2 later than t1. Remapping may occur periodically or responsive to external information indicating that an unexplored (uninhabited or unused) portion of an area may now be inhabited hence explored and/or be responsive to external information (or system-derived information), indicating that additional construction or renovation of buildings has occurred within the area.

All these elements may be positioned in accordance with the trails to create a map representing a floor.

If additional user information is given, it can be used to identify the functional purposes of different sections and rooms in the building. For example, if a room has been found which is relatively small, and in which people tend to walk in, then stop at a given position (e.g. after only two strides from the doorway), then turn around and walk out, this room may be a men's toilet stall or bathroom, where people (who are men) tend to walk up to a toilet, then, when stationary, urinate, then turn around and walk out. if a room has been found which is relatively small, and in which people tend to walk in, then turn around, then stop, and then walk out, this room may be a women's toilet stall or bathroom, where people (who are women) tend to walk up to a toilet, then turn around to face away from the toilet and, when stationary, sit on the toilet, then walk out.

Similarly, a given area may be identified as a parking lot if more than N users are detected in that area, transitioning from walking->sitting aka STOP class->driving.

It is appreciated that the system may distinguish sitting from standing, although this may not be possible for points in time at which a transition of the user's device's bodily position occurs. This distinction between sitting and standing may be made on the basis that the mean device's position when the user is standing, is not very different compared to when the user is walking, whereas the mean device's position when the user is sitting, is very different compared to when the user is walking (significant change e.g. 60-90 degrees in pitch orientation, between walking and sitting).

Driving may be detected, using either or both of the following criteria:
a. Longer accelerations occurring along a given direction and/or torques (angular velocities); for example, if a device accelerates, typically continuously, or increases monotonically, along a south-west axis for, say, two minutes or more, this is likely to be a device in a car, and not a device being held by a pedestrian.
b. “shakes”-some unrecognized significant movement occurs inter alia during driving.

Similarly, a given area may be identified as an elevator if more than N users are detected in that area, transitioning from stop->vertical acceleration->stop. And/or, users typically walk into an elevator i.e. in direction D, then become stationary as the elevator moves, then turn around and walk out in direction (−D). And/or, an elevator area may be identified if an over-threshold number of users stand stationary for a few minutes together, then walk forward together.

It is appreciated that an elevator would normally be found between gait episodes (time intervals in which gait is detected), whereas bus stops would normally precede a driving episode (time interval in which driving is detected, e.g., as evidenced by an interval of unrecognized movement/shakes).

Similarly, a given staircase may be identified as an escalator if more than N users are detected in that area, all engaging in stair-climbing, yet each taking a different number of strides. Some simply stand on the escalator and ride up/down (v=0), other users take one stride, still other users take more than one stride e.g. walk up the entire escalator.

Similarly, points of interest within a given area may be identified as places where people tend to stop, such as trash, sinks, refrigerators, microwaves and other cookers, and reception desk.

Similarly, a given area may be identified as a queue if users in that area are characterized by slow cadence and/or if many people follow the same trail at about the same time and/or people who arrive (strides detected) at a certain location, then all face in the same direction and walk, typically more slowly than before, typically with stops and starts, in a certain common direction.

c. Mapping spatial routes or walking routes for pedestrians and ranking their accessibility (for the disabled e.g.) for public services and municipalities. Plural trails produced by flow 10-40 may be generated and stored (e.g., cloud storage or other data storage) for further offline analysis. Once enough trails are collected (^{˜}10 per 100 square ft. per floor) indoors or outdoors, the aggregation of layers A of all trails can characterize the accessibility of the trail part. For example, one can make a “heat map” of the mean and standard gait speed (or for any other gait measure) in every (say) 100 sq ft (or any other resolution). Such a map can help municipalities identify locations where accessibility and/or movement are poor and need improvement. The difficulty may be that road quality at location x is poor, or that the location has become crowded for some reason; the area may then be selected for analysis by human experts and/or imaged to determine whether the problem is road quality or congestion, and take action accordingly. It is appreciated that currently municipalities do not have any systemic way to identify such locations; consequently, falls and injuries may occur, for example, which inconvenience the public and result in lawsuits against the municipality.

d. Navigating inside a building or built-up area e.g. navigating, typically for pedestrians, within a hospital or university or other campus (to find a given room or person or department or classroom), shopping center, e.g., to find a particular store or a particular counter or product within a store, amusement park, fair, public transport terminal, e.g., bus station, train station or airport to find a given gate, facility, e.g., restroom or elevator or person or bus-stop), or navigation for a courier seeking to arrive at a given customer's desk, or a specific department in a hospital. It is appreciated that GPS applications (such as Whatsapp, which, at a certain level do provide end-users (and their communicants) with the phone's (end user's) self-location, tend to be noisy inside buildings. Also, these GPS-based apps are not accurate to the room level. Accuracy of WhatsApp's location sharing feature (which uses GPS data from a user's cellphone device to derive the user's location in real-time) may currently be limited to about 20 meters, depending on the quality of the GPS signal and/or device calibration and/or network conditions and/or the surrounding environment; in areas with obstructions, e.g. buildings, WhatsApp's location sharing feature's accuracy may currently be even less precise than 20 meters.

Given a map of a building or built-up area, including staircases, corridors, halls, doorways, and rooms, a navigation application can be implemented similarly to a road navigation app, except that corridors may replace roads and/or cross-corridors replace crossroads and/or doorways may replace traffic lights, and/or staircases may replace, say, two-level interchanges where two roads meet and two levels, connected by ramps, ensure traffic going through does not meet.

e. Tracking workers (e.g. construction workers) for contractors, and construction companies. Given trials (operation 40 output) of a worker's daily activity, the contractor can track the number of times the worker picked up working materialfrom point A and used it in point B, how fast he moved from one point to another, at what frequency, and how long he spent at each point. The system can aggregate such statistics for all workers over the day and provide the contractor with a report for each worker. The contractor can define types of points over the map and rank workers by time spent on different working tasks, and the number of movements made from one point type to another.

It is appreciated that any recognition of locations, based on identifying characteristic motor behavior or motion patterns or gait patterns carried out by users present at those locations, is within the scope of the present invention. The characteristic motor behavior or motion patterns or gait patterns may be identified using any suitable technology or scheme such as deriving the characteristic motor behavior or motion patterns or gait patterns from accelerometer data generated by a user's mobile devices.

It is appreciated that any generation of urban, e.g., indoor maps, based on recognition of locations as above, is within the scope of the present invention.

It is appreciated that any use of urban, e.g., indoor maps, generated as above, is within the scope of the present invention

Typically, mapping is generated in advance, offline, e.g., by aggregating plural trajectories or tracks, then applying gait analysis to generate maps, e.g., as described above. Once maps have been generated, navigation instructions may be derived from these maps in real-time.

Certain embodiments of the present invention, provided standalone or in combination with any other embodiments described herein, partition motion into intervals; the intervals may be characterized or classified as one of plural interval types, the interval types typically including all or any subset of the following:
Device Transition aka position change—change of the position of the measurement device
Shake aka non-specific movement—some unrecognized significant movement;
Stops aka static—the measurement device is stationary, possibly indictating that the subject is standing in place, or that the measurement device is placed aside;
Turns—the subject is turning or changing course (direction of movement) between adjacent strides significantly (e.g. more than 30 degrees);
Strides aka walk interval.

An example of how this motion partitioning may be provided is now described; the data fusion method of flow 5 typially uses Kalman filtering, where filter parameters may differ depending (e.g., inter alia) on interval type.

Flow 5 aka FIG. 5 is a data fusion method which typically takes advantage of the gait analysis and semantic segmentation of the IMU data, and which may be used standalone or to implement operation 40 of FIG. 4. All or any subset of the following operations may be provided, suitably ordered e.g. as shown:
210: provide typically continuous inertial measurement over time, GPS locations at a rate of x (e.g. 5 per minute), and motion and gait analysis, e.g. as described with reference to FIG. 4. The processor may then be used to generate accurate estimation of a user's location by performing the following:
225: Use division of data into typically continuous segments of different types based on the type of activity or class detected by a suitable motion gait analysis pipeline, e.g., as described with reference to FIG. 4. See published, co-owned US 2022/0111257 page 21 as one method which may be employed for such division and/or another method for identifying five(say) classes is described above.
230: use the following derivations of Kalman Filter to fuse GPS (when available) with the IMU and/or stride length and/or the user's heading which may be obtained e.g. as described in published, co-owned US 2022/0111257.

Note that Kalman filtering typically uses a series of measurements observed over time to estimate unknown variables by estimating a joint probability distribution over the variables for various “time-steps”; k is an index over these time-steps.

Typically all or any subset of the following Kalman filter's parameter/s are to be modelled or defined for each time-step k, corresponding to each stride or interval following segmentation e.g. as described herein with reference to operation 30 in flow 4:
Fₖ, the state-transition model:
Hₖ, the observation model;
Qₖ, the covariance of the process noise;
Rₖ, the covariance of the observation noise;
uₖ, the control vector, representing the controlling input into control-input model.
Bₖ, the control-input model;

The Kalman filter model assumes that the true state at time k is evolved from the state at (k−1) e.g. according to

$${x}_{k} = {F}_{k} {x}_{k - 1} + {B}_{k} {u}_{k} + {w}_{k}$$

where.
Fₖ is the state transition model which is applied to the previous state xₖ₋₁;
Bₖ, is the control-input model which is applied to the control vector uₖ;
wₖ is the process noise, which is assumed to be drawn from a zero mean multivariate normal distribution, [symbol] , with covariance, Qₖ:wₖ˜ [symbol] (0,Qₖ).

At time k an observation (or measurement) zₖ of the true state xₖ may be made

$${z}_{k} = {H}_{k} {x}_{k} + {v}_{k}$$

where
Hₖ is the observation model, which maps the true state space into the observed space and
vₖ is the observation noise, which may be drawn from a zero mean multivariate normal distribution, [symbol] , with covariance, Rₖ:vₖ˜ [symbol] (0,Rₖ).

The initial state, and the noise vectors at each step {x₀, w₁, . . . , wₖ, v₁, . . . , vₖ} are all assumed to be mutually independent.

In embodiments herein, the state xx is the location of the device. The state-transition model, Fₖ, is always I; the state changes only due to the control vector and the process noise.

The observations zₖ are the GNSS events' location (Hₖ=I) matched to the interval k that corresponds to the event time (it is assumed that the intervals are short e.g. an order of magnitude shorter, compared to the GNSS accuracy ^{˜}10 meters), so an accuracy of a second is negligible. Rx is always provided as part of the event (e.g. developer.android.com/reference/android/location/Location.html, support.swiftnav.com/support/solutions/articles/44002097796-gnss-receiver-estimated-accuracy-tutorial, www.webpilot.ai/writeDetail/96d9d7f3-b4be-4d5e-b661-bd8840ace359?lang=en-US)
Qₖ, Bₖ, uₖ are defined in correspondence to their interval type derived from operation 430. For example:
230a: The detected interval type is “stop”; it is assumed that the location is stationary and that the velocity is zero (this reduces the error caused by the inaccuracies of the GPS and the drift caused by the IMU). Thus: Fₖ=I (The previous location xₖ₋₁ does not change) and Qₖ, Bₖ, uₖ are all zero.
230b: Given that the interval is a stride in a walking segment, which is not a turn, provided with its length and heading direction:
   uₖ is the vector of displacement which may be computed from the stride length and the heading, so Bₖ=I is trivial.
   Qₖ, is the noise derived from the stride length and heading estimation accuracy. E.g., Qₖ= [symbol] (0, 10 cm), means no error of heading but 10 cm RMSE Aka Root mean square error of stride length. This information is set according to the reported algorithms' accuracy.
230c: The interval type is “turn” (the angle between the current stride and the previous is greater than a threshold e.g. 30 degrees):
The stride length and heading are still available from operation 430, though they are less accurate.
   uₖ is the vector of displacement which may be computed from the stride length and the heading, Bₖ=I as before. Alternatively, one can multiply by a factor<1 (e.g. 0.5) as a heuristic that considers how strides become shorter in turning.
   Qₖ, is in the magnitude (e.g. factor=1) of the estimated stride. E.g., Qₖ= [symbol] (0,uₖ).
230d: The interval type is shake, noise, or device transitions; there are two options:
   1. The ML approach. E.g. ronin.cs.sfu.ca/
      a. Process the IMU data using a pre-trained ML model (such as RONIN) to extract velocity and heading at a frequency of say 1 Hz.
      b. uₖ is the vector of displacement which may be computed from the velocity, the heading, and the frequency; Bₖ=I as before.
      c. Qₖ, is the noise derived from the model's accuracy. E.g., Qₖ= [symbol] (0, 10 cm), means no error of heading but 10 cm RMSE of stride length. This information is set according to the reported accuracy.
   2. The standard fusion method of IMU data and GNSS using a Kalman filter (or Extended Kalman Filter, EKF)—E.g. www.mdpi.com/1424-8220/23/7/3676

It is appreciated that interval types (a term used herein to refer to classification/s of intervals or windows of time, within a typically continuous stream of accelerometer output data) may alternatively or in addition be used for purposes other than determining Kalman filter parameters, e.g., as described herein.
240: Given all GNSS observations z₁, . . . , zₙ, use Kalman Smoothing methods (e.g. Rauch-Tung-Striebel or Modified Bryson-Frazier smoother) to estimate the device's location at step k, denoted as \hat{x}_{k|n} for k≤n.
250: Predict the rest of the location estimations \hat{x}_{k|k-1} for all k>n, using a Kalman filter (or EKF for the appropriate intervals—i.e. 230d).

An urban map-building use case which may be performed by an embodiment of the system described herein includes processing users' cellphone data, e.g. by performing one or both of the following operations:
a. Using a hardware processor for analyzing at least accelerometer (IMU) data provided by cellphones of at least a threshold number of users in a given location including recognizing at least one urban feature at said given location each time at least the threshold number of users, known to be present at the given location, exhibit a given motion pattern known by the processor to be characteristic of said urban feature; and
b. generating a map including a stored representation of said at least one urban feature which is associated in memory with said given location at which the accelerometer data indicative of the urban feature was collected.

Typically, each time a user located at location x (e.g. as defined by a GPS) climbs stairs at location x, the system increments a stairs-counter at location x, and there is a threshold number of people (e.g. 30, or more, or less) for (at least) staircases. if location x's counter reaches 30, a staircase is “declared” at location x e.g. a map of location X will indicate the presence of a staircase there.

Similarly, each time presence of an urban feature F (e.g. room, staircase, parking area etc.) is identified at location x (as identified by GPS) based on one user's accelerometer data, a counter is established (for feature F, at location x) and F is determined to be present at location x (e.g. the map of location x includes F) as soon as the counter (for feature F, at location x) has achieved a threshold value.

Any suitable method may be employed to generate a map from identified urban features. The map typically has a raster representation. For example, the system may be configured to use a grid (say 1m×1m or 0.1×0.1). Assume for example there is a trail on that grid, grid cells with >N & >P % stops are doors (if the resolution is higher e.g. in the case of 0.1×0.1, then counting can be evaluated on neighboring<3 cells).

A feature may also comprise a partial building, or a partial floor.

It is appreciated that the system herein does not necessarily group or partition building features, or more generally urban features, into urban structures e.g. buildings. For example, the system may or may not know whether a first room found at one location (e.g. as identified by a GPS) and a second room found 20 meters away, are both part of one single building, or whether they are parts of first and second different buildings respectively. Also, the system may or may not know whether a parking area is indoors or outdoors.

References to building features herein may be replaced by references to urban features generally.

Operations may also include deriving, from the map of the at least one urban structure, at least one route for vehicles/pedestrians to follow, including providing navigation instructions to users.

A motion pattern may be expressed in terms of at least one gait parameter, e.g., cadence, which characterizes a user's stride or gait cycle. It is appreciated that co-owned US20200289027A1 inter alia segments gait into plural cycles aka stride.

Methods for performing such segmentation may be as described in Perez, Andres A., and Miguel A. Labrador. “A smartphone-based system for clinical gait assessment.” 2016 IEEE International Conference on Smart Computing (SMARTCOMP). IEEE, 2016; and/or Gadaleta, Matteo, and Michele Rossi. “Idnet: Smartphone-based gait recognition with convolutional neural networks.” Pattern Recognition 74 (2018): 25-37.

Typically, a user's gait is characterized by averaging stride characteristics computed separately for each of plural strides by the same user (e.g. as though the user were on a treadmill) and/or by deriving stride characteristics from representative stride data, for a given user, which is generated by combining time-stamped accelerometer data, over plural strides, for each time-stamp from the time-stamp of the stride's beginning and until the time-stamp of the stride's end.

Typically, the system is configured to derive gait parameters from each stride along the trail separately.

Typically, the system is configured to aggregate plural trails/trajectories from plural measurement sessions.

Typically, the system is configured to use repetitive elements (such as doors, elevators) to anchor trails to each other.

Aggregation of plural trails may for example proceed as follows, and may include all or any subset of the operations described below in any suitable order, e.g., the order appearing below:

Given plural trails including intervals within a distance of, say, 10 meters (same level, no difference in height above sea level) from one another, they might share partial mutual routes/trail/trajectory. This problem of matching roots is related to map matching (en.wikipedia.org/wiki/Map_matching#) without an existing graph representing an underlying map of routes. In addition, in this case, trails may have a bias in the initial position/location and the calibrated north, resulting from a limited number of accurate GNSS events. Thus, the system may seek to find a bias fix in rotation and displacement for each trail, such that an underlying map would match the given trails as much as possible. The fix is limited by, say, 10 meters for the displacement and 20 degrees for trails with at least 3 GNSS events or unlimited (360 degrees) for trails with less than 3 GNSS events. The system may measure the match's strength using a matching score, e.g., as defined below. The system may use an optimization algorithm to find a bias-fix solution for all trials.

Matching score: the system may define the score using distances between prominent trail elements. Prominent elements are turns and stops (regardless of actual urban features) detected on the trails, and their locations are computed in FIG. 5. The underlying map may include, or may alternatively consist of, prominent elements corresponding to all prominent elements of the trails. Its score is typically the sum of all distances to the corresponding elements of all trails-every prominent element is linked to its nearest map's element of the corresponding type. There typically must be such an underlying map, since the trivial map, consisting of all trails elements, is an instance of one.

Optimizing the map and finding the biases fix may include all or any subset of the following operations suitably ordered, e.g., as follows:
1700—Extract the prominent elements for each trial. For each trail generated using flow 5, produce a list including all turning and stop intervals with their locations. Keep only trails with at least three prominent elements.
1710—Create an initial underlying map consisting of all of the prominent elements from all trials produced in step 1700.
1720—for each type: stops and turns, cluster the locations using single-linkage clustering (en.wikipedia.org/wiki/Single-linkage_clustering) and stop before a cluster radius (distance from its centroid to its most distant point) reaches say 1m. Use clusters' centroids to determine the number of clusters for each type and their initial locations.
1730—start an expectation maximization iterative process (a modification of the k-mean algorithm-en.wikipedia.org/wiki/K-means_clustering) to optimize the map by minimizing the matching score:
1730a—Expectation operation: For each type, use the clusters' centroids as the locations of the underlying map's prominent elements, and link each trail's prominent elements to its nearest map's element. Modify cluster centroids to the centroid of the modified linked element's locations for each cluster. Evaluate the matching score.
1730b—Maximization operation—for each trail, find the optimal bias in rotation and displacement that minimizes the sum of distances to the underlying map's prominent elements. It is a 2D linear alignment, which can be solved with least squares analytically (www.cs.cmu.edu/^{˜}16385/s17/Slides/10.1_2D_Alignment_LLS.pdf).

Either operation typically minimizes the score which is bound by 0. Therefore, this process does typically converge. In order to ensure it does not take an infinite number of steps, the system may use a lower bound for the score decrease between iteration of several iterations to verify that the score decreases significantly, otherwise the process stops.

It is appreciated that, typically, the expectation operation 1730a minimizes the matching score because it includes or alternatively consists of the k-means steps that minimize the same score. The maximization operation 1730 B minimizes the matching score by definition.
1730—When the iterations stop, the biases fix found may be used to align the trails.

This method can be repeated after the trails are aligned to generate more appropriate initial prominent elements from the beginning of the process.

Quality of gait typically includes cadence and/or other gait parameters. Gait analysis may include quantifying gait quality by computing gait parameters. No gait analysis and quality measures, besides stride length and heading for each stride, need be used to improve trail resolution (and PDR) accuracy; these measures may, for example, be used for deriving accessibility features or structural elements for further use cases rather than for trail reconstruction.

According to certain embodiments, the system may identify functionality of urban features by identifying “motion patterns” e.g. temporal sequences (along a trail e.g.) of gait characteristics such as for an elevator, parking lot, e.g., as described herein.

One example of an urban feature comprises a staircase, and the motion pattern known by the method to be characteristic of the staircase comprises the execution of stair-climbing activity. Data from at least one user's mobile phone's accelerometer is used to classify said user's motion as either stair-climbing activity, or as at least one activity other than stair-climbing.

Any suitable method may be employed to identify stair-climbing activity by gait analysis e.g. as described in co-owned, published US20200289027A1 and/or in published, co-owned US 2022/0111257

It is appreciated that, e.g. as described in co-owned, published US20200289027A1:
a. an end-user's stride cadence may differ depending on whether s/he is climbing stairs or walking.
b. the system may use a classifier to determine the device's bodily position and/or the activity in which the end-user is currently engaged, e.g. motion in a plane/going up stairs/going down stairs etc.).
c. The classifier may classify simultaneously along two dimensions: device position (in pocket/hand etc.)×user activity e.g. as above. The difference in the device's bodily position between going up stairs motion and going downstairs motion can be distinguished by the direction of convexness: a left front pocket position looks convex relative to the right/down direction (when looking at the user's movement from the top point of view and assuming forward is the x axis (to the right), motion to the left is up, on the page, whereas right is down). The right front pocket position is convex relative to the left/up direction. If motion starts at 0,0(,0) and ends with a V-like shape, the difference is also apparent as the movement ends. When the V opens to the left, the device is in the left pocket and vice-versa; if the V opens to the right, the device is in the right pocket.

User activity classes may include all or any subset of walking, ascending or climbing up stairs, descending or climbing down stairs, running, jumping, squatting, skipping, and hopping.

It is appreciated that an end-user's running up stairs may be classified, according to certain embodiments, as either “running” or “climbing stairs” where, typically, if double support (both legs on the ground)>0% then the classification is “climbing stairs” and otherwise the classification is “running”.
d. the system may, if desired, unite plural ones of the above classes, into a single class.
e. when the bearer of the mobile device, or end-user, climbs stairs, then if the device e.g. bearer's phone is fixed relative to the thigh (e.g. in a hip pocket), the swing that starts the motion gets high relative to the mean trajectory's (or trail's) position of the sensor over the repetitive activity, followed by mainly vertical movement to lift the end-user's body up to the next step in the flight of stairs, and so the thigh gets lower than e.g. the mean of the sensor's trajectory or trail (the repetitive pattern representation described in X and Y applications). When going down stairs, the swing ends lower compared to going up stairs. This is helpful inter alia for distinguishing between climbing stairs and descending stairs, either as a heuristic or by defining this distinction as an ML task.

It is appreciated that any suitable method may be employed for stair-climbing detection, including but not limited to performing all or any subset of the following operations, suitably ordered e.g. as follows:
a. Collect accelerometer data from plural e.g. 100 users climbing stairs, and from a similar number of users performing N other activities.
b Produce the repetitive pattern representation e.g. as described in co-owned US 2023/0137198 at inter alia.
c. train a classifier—e.g. three cyclic convolutional layers as described in co-owned, published US 2023/0137198 and a dense layer with a softmax activation with the size of N+1 at the end for each activity and typically one more for an unknown activity i.e. activity other than the known N+1 activities. The output which may be generated by the classifier is the estimated probability that each activity is the measured activity, or the estimated probability that certain accelerometer outputs were measured, while the user bearing the accelerometer was engaged in activity 1 vs. activity 2 vs . . . activity n vs. activity n+1.

This classifier is useful to detect activities: for example, given four classes a b c d and the probabilities, the classifier answers “activity=d” each time the highest of the four probabilities is, say, the probability associated with class D. Typically, after softmax, it turns out that results include one cell/index closer to 1 and the others are almost 0, thus if results are very close to one another, e.g., four probabilities each one close to 25%, then typically the classifier answers that the activity is unknown, which may be in addition to the cell specified for the “unknown” category.

Stair-climbing detection may or may not be defined as an ML task, in the system herein.

It is appreciated that analysis of stair-climbing (say) may differ from analysis of another activity e.g. walking (even up a hill).

Gait analysis may proceed according to clinical standards. Stair-climbing analysis may be different (e.g. stride length is not applicable for stairs) but may have some resemblances e.g. cadence, and cadence variability may be measured both for stair-climbing and for walking. Stair patterns (like step-to) may be unique to stair-climbing e.g. when a user climbs one stair with one leg, then brings the other leg up to the same stair.

It is appreciated that terminology such as “mandatory”, “required”, “need” and “must” refer to implementation choices made within the context of a particular implementation or application described herewithin for clarity, and are not intended to be limiting, since, in an alternative implementation, the same elements might be defined as not mandatory and not required, or might even be eliminated altogether.

Components described herein as software may, alternatively, be implemented wholly or partly in hardware and/or firmware, if desired, using conventional techniques, and vice-versa. Each module or component or processor may be centralized in a single physical location or physical device or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order, including simultaneous performance of suitable groups of operations, as appropriate. Included in the scope of the present disclosure, inter alia, are machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order, i.e., not necessarily as shown, including performing various operations in parallel or concurrently, rather than sequentially, as shown; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform, e.g., in software, any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented, e.g., by one or more processors. The invention shown and described herein may include (a) using a computerized method to identify a solution to any of the problems or for any of the objectives described herein, the solution optionally including at least one of a decision, an action, a product, a service or any other information described herein that impacts, in a positive manner, a problem or objectives described herein; and (b) outputting the solution.

The system may, if desired, be implemented as a network—e.g., web-based system employing software, computers, routers, and telecommunications equipment, as appropriate.

Any suitable deployment may be employed to provide functionalities, e.g., software functionalities shown and described herein. For example, a server may store certain applications, for download to clients, which are executed at the client side, the server side serving only as a storehouse. Any or all functionalities, e.g., software functionalities shown and described herein, may be deployed in a cloud environment.

Clients, e.g., mobile communication devices such as smartphones, may be operatively associated with, but external to the cloud.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Any “if-then” logic described herein is intended to include embodiments in which a processor is programmed to repeatedly determine whether condition x, which is sometimes true and sometimes false, is currently true or false, and to perform y each time x is determined to be true, thereby to yield a processor which performs y at least once, typically on an “if and only if” basis, e.g., triggered only by determinations that x is true, and never by determinations that x is false.

Any determination of a state or condition described herein, and/or other data generated herein, may be harnessed for any suitable technical effect. For example, the determination may be transmitted or fed to any suitable hardware, firmware, or software module, which is known or which is described herein to have capabilities to perform a technical operation responsive to the state or condition. The technical operation may, for example, comprise changing the state or condition, or may more generally cause any outcome which is technically advantageous, given the state or condition or data, and/or may prevent at least one outcome which is disadvantageous, given the state or condition or data. Alternatively or in addition, an alert may be provided to an appropriate human operator or to an appropriate external system.

Features of the present invention, including operations which are described in the context of separate embodiments, may also be provided in combination in a single embodiment. For example, a system embodiment is intended to include a corresponding process embodiment, and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art, and particularly, although not limited to those described in the Background section or in publications mentioned therein.

Conversely, features of the invention, including operations, which are described for brevity in the context of a single embodiment or in a certain order, may be provided separately or in any suitable sub-combination, including with features known in the art (particularly although not limited to those described in the Background section or in publications mentioned therein) or in a different order. “e.g.” is used herein in the sense of a specific example which is not intended to be limiting. Each method may comprise all or any subset of the operations illustrated or described, suitably ordered e.g. as illustrated or described herein.

Devices, apparatus or systems shown coupled in any of the drawings may in fact be integrated into a single platform in certain embodiments, or may be coupled via any appropriate wired or wireless coupling, such as but not limited to optical fiber, Ethernet, Wireless LAN, HomePNA, power line communication, cell phone, Smart Phone (e.g. iPhone), Tablet, Laptop, PDA, Blackberry GPRS, Satellite including GPS, or other mobile delivery. It is appreciated that in the description and drawings shown and described herein, functionalities described or illustrated as systems and sub-units thereof can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation, and is not intended to be limiting.

Any suitable communication may be employed between separate units herein, e.g., wired data communication and/or in short-range radio communication with sensors such as cameras e.g., via Wifi, Bluetooth, or Zigbee.

It is appreciated that implementation via a cellular app as described herein is but an example, and, instead, embodiments of the present invention may be implemented, say, as a smartphone SDK, as a hardware component, as an STK application, or as suitable combinations of any of the above.

Any processing functionality illustrated (or described herein) may be executed by any device having a processor, such as but not limited to a mobile telephone, set-top-box, TV, remote desktop computer, game console, tablet, mobile e.g. laptop or other computer terminal, embedded remote unit, which may either be networked itself (may itself be a node in a conventional communication network e.g.) or may be conventionally tethered to a networked device (to a device which is a node in a conventional communication network, or is tethered directly or indirectly/ultimately to such a node).

Any operation or characteristic described herein may be performed by another actor outside the scope of the patent application and the description is intended to include apparatus whether hardware, firmware or software which is configured to perform, enable, or facilitate that operation or to enable, facilitate, or provide that characteristic.

The terms processor or controller or module or logic as used herein are intended to include hardware such as computer microprocessors or hardware processors, which typically have digital memory and processing capacity, such as those available from, say Intel and Advanced Micro Devices (AMD). Any operation or functionality or computation or logic described herein may be implemented entirely or in any part on any suitable circuitry including any such computer microprocessor/s as well as in firmware or in hardware or any combination thereof.

It is appreciated that elements illustrated in more than one drawing, and/or elements in the written description, may still be combined into a single embodiment, except if otherwise specifically clarified herewithin. Any of the systems shown and described herein may be used to implement or may be combined with, any of the operations or methods shown and described herein.

It is appreciated that any features, properties, logic, modules, blocks, operations, or functionalities described herein which are, for clarity, described in the context of separate embodiments, may also be provided in combination in a single embodiment, except where the specification or general knowledge specifically indicates that certain teachings are mutually contradictory and cannot be combined. Any of the systems shown and described herein may be used to implement or may be combined with, any of the operations or methods shown and described herein.

Conversely, any modules, blocks, operations or functionalities described herein, which are, for brevity, described in the context of a single embodiment, may also be provided separately or in any suitable sub-combination, including with features known in the art. Each element, e.g., operation described herein may have all characteristics and attributes described or illustrated herein, or, according to other embodiments, may have any subset of the characteristics or attributes described herein.

It is appreciated that apps implementing any functionality herein may include a cell app, mobile app, computer app, or any other application software. Any application may be bundled with a computer and its system software, or published separately. The term “phone” and similar used herein is not intended to be limiting and may be replaced or augmented by any device having a processor, such as but not limited to a mobile telephone, or also set-top-box, TV, remote desktop computer, game console, tablet, mobile, e.g., laptop or other computer terminal, embedded remote unit, which may either be networked itself (may itself be a node in a conventional communication network e.g.) or may be conventionally tethered to a networked device (to a device which is a node in a conventional communication network or is tethered directly or indirectly/ultimately to such a node). Thus, the computing device may even be disconnected from e.g., WiFi, Bluetooth, etc., but may be tethered directly or ultimately to a networked device.

References herein to “said (or the) element x” having certain (e.g., functional or relational) limitations/characteristics, are not intended to imply that a single instance of element x is necessarily characterized by all the limitations/characteristics. Instead, “said (or the) element x” having certain (e.g. functional or relational) limitations/characteristics is intended to include both (a) an embodiment in which a single instance of element x is characterized by all of the limitations/characteristics and (b) embodiments in which plural instances of element x are provided, and each of the limitations/characteristics is satisfied by at least one instance of element x, but no single instance of element x satisfies all limitations/characteristics. For example, each time L limitations/characteristics are ascribed to “said” or “the” element X in the specification or claims (e.g. to “said processor” or “the processor”), this is intended to include an embodiment in which L instances of element X are provided, which respectively satisfy the L limitations/characteristics, each of the L instances of element X satisfying an individual one of the L limitations/characteristics. The plural instances of element x need not be identical. For example, if element x is a hardware processor, there may be different instances of x, each programmed for different functions and/or having different hardware configurations (e.g., there may be three instances of x: two Intel processors of different models, and one AMD processor).

1. A method for processing users' cellphone data, the method comprising:
a. using a hardware processor for analyzing at least accelerometer (IMU) data provided by cellphones of at least a threshold number of users in a given location including recognizing at least one urban feature at said given location each time at least the threshold number of users, known to be present at the given location, exhibit a given motion pattern known by the processor to be characteristic of said urban feature; and
b. generating a map including a stored representation of said at least one urban feature which is associated in memory with said given location at which the accelerometer data indicative of the urban feature was collected.

2. The method of claim 1 and also comprising deriving, from the map of the at least one urban structure, at least one route for vehicles/pedestrians to follow, including providing navigation instructions to users.

3. The method of claim 1 wherein said urban feature comprises a corridor and wherein the motion pattern known by the method to be characteristic of a corridor comprises a (typically) continuous sequence of strides over the trail without stops or interruptions.

4. The method of claim 1 wherein said urban feature comprises a hall and wherein the motion pattern known by the method to be characteristic of a hall comprises continuous sequences of strides crossing each other rather than overlapping.

5. The method of claim 1 wherein said urban feature comprises a doorway and wherein the motion pattern known by the method to be characteristic of a doorway comprises (above x % threshold) stops from among a set of users proceeding along the trail; there may not be 100% stops since the doorway may sometimes be open.

6. The method of claim 1 wherein said urban feature comprises a parking area and wherein the motion pattern known by the method to be characteristic of the parking area comprises more than N1 users in that area, transitioning from walking->sitting aka STOP class->driving and/or more than N2 users in that area, transitioning from driving->sitting aka STOP class->walking.

7. The method of claim 1 wherein said urban feature comprises a room, and wherein the motion pattern known by the method to be characteristic of a room comprises a pattern wherein all trails arriving at a certain location go through a doorway.

8. The method of claim 1 wherein said urban feature comprises a staircase, and wherein the motion pattern known by the method to be characteristic of the staircase comprises execution of stair-climbing activity, and wherein data from at least one user's mobile phone's accelerometer is used to classify said user's motion as either stair-climbing activity or as at least one activity other than stair-climbing.

9. An improved tracking system comprising a hardware processor configured for:
tracking at least one user by repeatedly computing at least one user's current location including estimating the user's movements from a previously known location of said user, thereby to generate a trail followed by the user; and
partitioning said trail into footsteps aka foot traces.

10. An improved tracking method comprising:
tracking at least one user by repeatedly computing at least one user's current location including estimating the user's movements from a previously known location of said user, thereby to generate a trail followed by the user; and
partitioning said trail into footsteps aka foot traces.

11. The method of 10 wherein said using and/or said generating is used for at least one of:
a. Tracking pedestrian trail and estimating trail distance
b. Mapping rooms inside a building
c. Mapping spatial routes or walking routes for pedestrians and ranking their accessibility
d. Navigating inside a building or built-up area.

12. The method of claim 10 wherein said partitioning comprises extraction of gait analysis from inertial data; and
fusion of GPS data, when available, with IMU readings aka inertial measurements and/or gait analysis output e.g. stride length and/or the user's heading.

13. The method of 12 wherein a Kalman filter or derivation thereof is used for said fusion.

14. The method of claim 13 wherein said Kalman filter has at least one parameter whose value/s differ/s between motion interval types.

15. The method of claim 14 wherein said motion interval types comprise at least one of:
Device Transition—change of the position of the measurement device
Shake—some unrecognized significant movement
Stops—the measurement device is stationary, possibly indicating that the subject is standing in place, or that the measurement device is placed aside
Turns—the subject is turning or changing course (direction of movement) between adjacent strides significantly (e.g. more than 30 degrees)
Strides

16. The method of claim 12 wherein said inertial data comprises typically continuous inertial data calibrated to the north and/or GPS locations over time.

17. The method of claim 1 wherein said tracking and/or said portioning is used for at least one of:
a. Tracking pedestrian trail and estimating trail distance
b. Mapping rooms inside a building
c. Mapping spatial routes or walking routes for pedestrians and ranking their accessibility
d. Navigating inside a building or built-up area.
